(19) United States
(12) Patent Application Publication
(10) Pub. No.: US 2015/0140158 A1
(43) Pub. Date: May 21, 2015

(54) THREE-DIMENSIONAL PRINTING SYSTEMS

(71) Applicant: Solidoodle, Inc., Brooklyn, NY (US)

(72) Inventors: Samuel CERVANTES, Brooklyn, NY (US); Xiaoquan LOU, Bronx, NY (US); Yeon KIM, Brooklyn, NY (US)

(21) Appl. No.: 14/543,614

(22) Filed: Nov. 17, 2014

Related U.S. Application Data
(60) Provisional application No. 61/984,593, filed on Apr. 25, 2014.
(60) Provisional application No. 61/914,570, filed on Dec. 11, 2013.
(60) Provisional application No. 61/905,499, filed on Nov. 18, 2013.

(51) Int. Cl. B29C 67/00

(52) U.S. Cl. CPC B29C 67/0085; B29C 67/0051; B33Y 30/00
USPC 425/461; 248/637; 312/327

(57) ABSTRACT

Three-dimensional printing systems are disclosed that are reliable, accurate and easy to use. Leveling sub-systems including a leveler ramp for raising and lowering a measurement probe to determine and adjust the height of an extrusion head with respect to the build platform are disclosed. X-Y translation gantries and extrusion heads that are easy to use and assemble are also disclosed.

This application claims the benefit under 35 U.S.C. §119(e) of U.S. Provisional Application No. 61/984,593, filed on Apr. 25, 2014, U.S. Provisional Application No. 61/914,570, filed on Dec. 11, 2013, and U.S. Provisional Application No. 61/905,499, filed on Nov. 18, 2013, each of which is incorporated by reference in its entirety.

### FIELD

The present disclosure relates to the field of three-dimensional prototype modeling, also referred to as three-dimensional printing. Three-dimensional printing systems and sub-assemblies are disclosed that are reliable, accurate, and easy to use.

### BACKGROUND

Three-dimensional printing systems are used to form three dimensional objects by depositing multiple layers of a material in a fluid state from an extrusion head onto a base. The material solidifies and multiple layers are built up to form the object. Design data for forming an object can be imported from a computer aided design system. There is recent interest in producing three-dimensional printing systems that are sufficiently low in cost that they can be accessible to the hobbyist and that are also reliable, easy to use and produce high quality objects.

### SUMMARY

Three-dimensional printing systems that are simple to use, reliable, and produce high-quality objects are disclosed. These and other objectives are realized, at least in part, by the design of the translation carriages, the extrusion head, and the leveling sub-system.

In a first aspect, leveling sub-systems for leveling a three-dimensional printing system is provided, comprising a vertically adjustable leveler probe mounted to an extrusion head; and a leveler ramp mounted to a gantry assembly, wherein the leveler ramp comprises a lowering ramp and a raising ramp.

In a second aspect, methods of leveling a three-dimensional printing system comprising are provided, comprising providing a build platform; an X-Y translation gantry disposed over the build platform; a leveler ramp mounted to the X-Y translation gantry; an extrusion head mounted to the X-Y translation gantry; and a leveler probe mounted to the extrusion head, wherein the leveler ramp comprises a lowering ramp and a raising ramp; from a starting position, moving the extrusion head toward the leveler ramp to cause the leveler probe to engage the lowering ramp; moving the extrusion head and the leveler probe along the lowering ramp to lower the leveler probe toward the build platform to a measurement position; moving the lowered leveler probe with respect to the build platform to determine the distance between the leveler probe and the build platform at various locations across the build platform; from an ending position, moving the extrusion head toward the leveler ramp to cause the leveler probe to engage the raising ramp; and moving the extrusion head and the leveler probe along the raising ramp to raise the leveler probe away from the build platform to a build position.

In a third aspect, translation carriages for three-dimensional printing systems are provided, wherein the translation carriage comprises an X-carriage rod; a guide rail mounted parallel to the X-carriage rod; an extruder mount slidably coupled to the X-carriage rod and slidably coupled to the guide rail; and an X-carriage drive belt operatively coupled to the extruder mount, wherein the X-carriage drive belt is configured to move the extruder mount along the X-carriage rod and along the guide rail.

In a fourth aspect, extrusion heads for three-dimensional printing systems are provided, wherein the extrusion head comprises a front plate; a front heat sink; and a back heat sink, wherein, each of the front heat sink and the back heat sink comprise a channel configured to pass a printing filament and configured to retain at least a portion of an extruder barrel; and the front plate and the front heat sink are mounted to the back heat sink with at least two thumbscrews.

In a fifth aspect, enclosures for three-dimensional printing system are provided, wherein the enclosure comprises four substantially vertical side walls; a hinged insert configured to mate with each of the four vertical side walls, wherein the hinged insert comprises a recess for mounting a filament spool and a hole for feeding filament to an extruder head; and a hinged top cover configured to mate with and to cover the hinged insert.

### BRIEF DESCRIPTION OF THE DRAWINGS

Those skilled in the art will understand that the drawings, described herein, are for illustration purposes only. The drawings are not intended to limit the scope of the present disclosure.

FIGS. 1-3 show perspective views of a three-dimensional printing system enclosure according to certain embodiments.

FIG. 4 shows a cut away view of a three-dimensional system according to certain embodiments.

FIG. 5 shows a perspective view of an X-carriage and a Y-carriage according to certain embodiments.

FIGS. 6 and 7 show perspective views of an X-carriage and Y-carriage assemblies according to certain embodiments.

FIG. 8 shows a detailed view of the X-carriage assembly according to certain embodiments.

FIGS. 9A, 9B, 10A, and 10B show detailed views of the apparatus for mounting the X-carriage assembly to the Y-carriage assembly.

FIG. 11 shows a cross-sectional view of an extruder head according to certain embodiments.

FIGS. 12-15 show perspective views of an extruder head and extruder head components according to certain embodiments.

FIGS. 16A and 16B show front and back perspective views, respectively, of a heat sink according to certain embodiments.

FIG. 17 shows a view of an extruder mounted on an X-carriage according to certain embodiments.

FIG. 18 shows an exploded view of various components of an extruder head according to certain embodiments.

FIG. 19 shows a side view of a gantry with a leveler ramp according to certain embodiments.

FIG. 20 shows a perspective view of a gantry with a leveler ramp according to certain embodiments.

FIGS. 21 and 22 show perspective views of an extruder head with a leveler probe in the raised position and the lowered position, respectively, according to certain embodiments.

FIG. 23 shows a perspective view of a leveler probe mount according to certain embodiments.

FIGS. 24-30 show a sequence of steps for lowering and raising a leveler probe according to certain embodiments.

Reference is now made to certain embodiments of compositions and methods. The disclosed embodiments are not intended to be limiting of the claims. To the contrary, the claims are intended to cover all alternatives, modifications, and equivalents.

### DETAILED DESCRIPTION

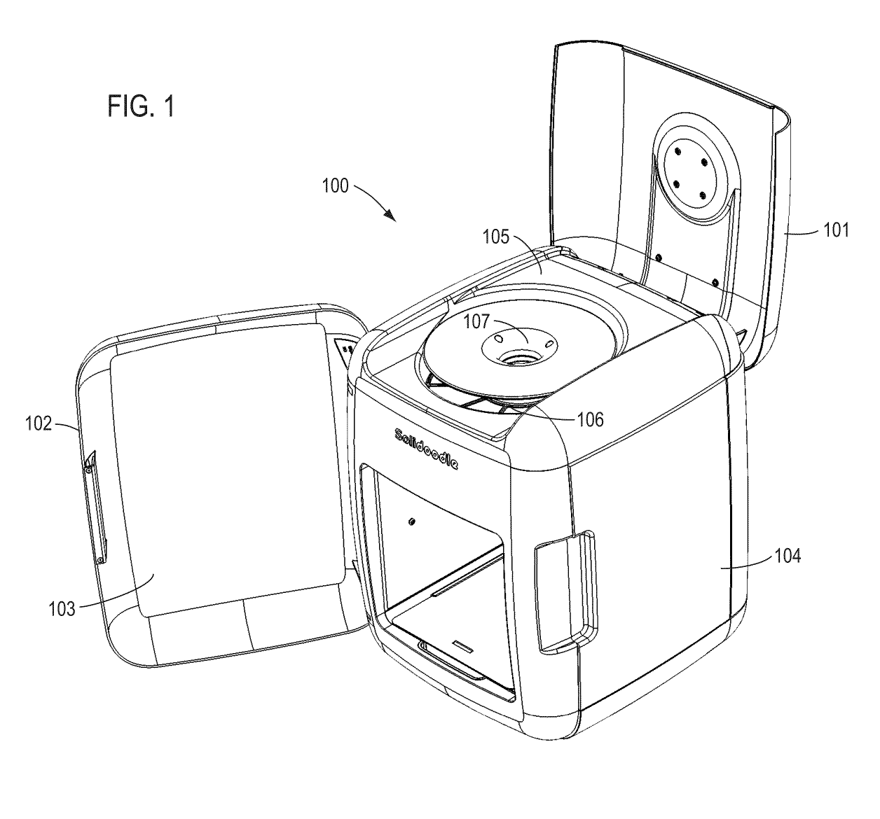

Perspective views of an example of a three-dimensional (3D) printing system provided by the present disclosure are shown in FIGS. 1-3. The 3D printing system 100 shown in FIG. 1 includes a hinged top cover 101, a hinged front panel 102 with a viewing window 103, and side and back panels 104. The panels are mounted to a frame. Side and back panels 104 can be slot-fitted into the bottom of the enclosure and then rotated upward to be secured by bolts into the top of the frame to which the panels are attached. Other mechanisms for attaching and retaining the side and back panels can be used. Enclosure 100 contains the apparatus for making a 3D object and can also house the electronics for operating the 3D printing system. The enclosure provides a somewhat regulated thermal environment during part fabrication and protects the fabrication apparatus. The design of the panels and the attachment of the panels to the frame are intended to provide easy access to the internal parts contained within the enclosure.

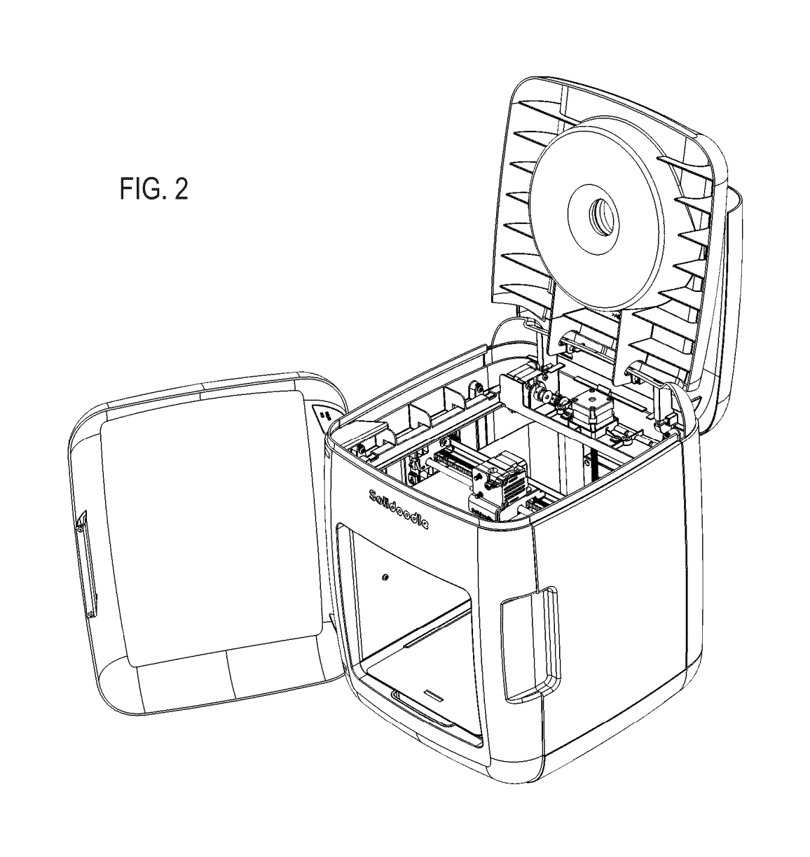

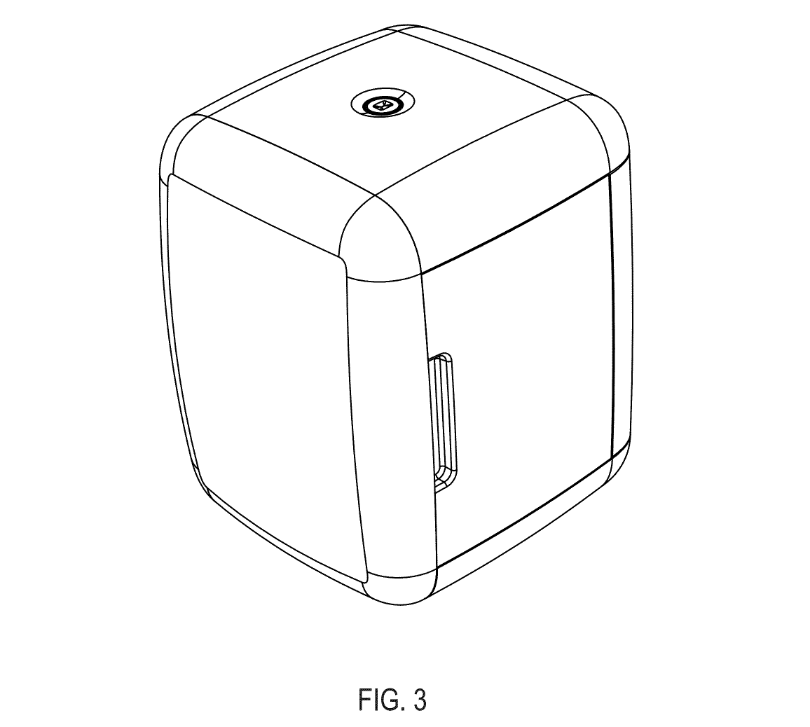

The top includes hinged top cover 101 and insert 105. Insert 105 includes a cavity 106 for retaining a filament coil and a center hole 107 for feeding filament to an extrusion head. Insert 105 can be hinged to provide easy access to the internal components of the 3D printing systems. A view with the top cover 101, the insert 105, and the front panel open is shown in FIG. 2. FIG. 3 shows a view of a 3D printing apparatus with all covers and panels closed.

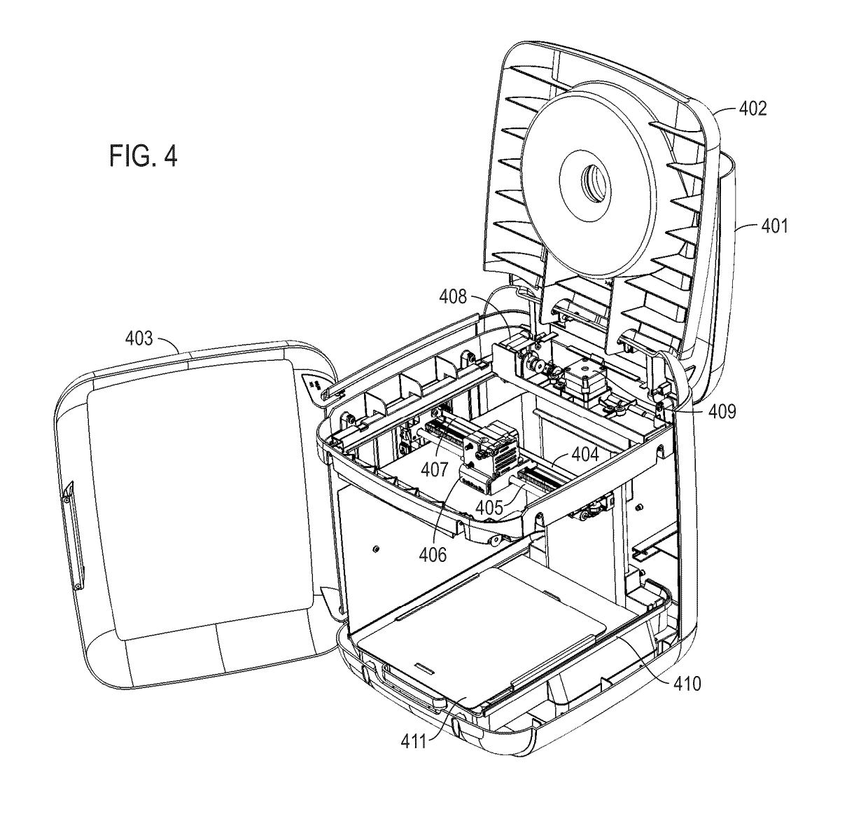

FIG. 4 shows a cut-away perspective view of a 3D printing apparatus. FIG. 4 shows top cover 401, insert 402, front cover 403, X-carriage assembly 404, X-carriage rod 405, extruder mount 406, extruder 407, Y-carriage motor 408, vertical drive motor 409, build platform 410, and slidable build platform 411. Fabricated parts can be easily accessed using the slidable build platform 410.

In certain embodiments, the enclosure defines a square with a characteristic dimension of about 12 inches. The enclosure may be larger or smaller depending, for example, on the size of the parts intended to be fabricated. The enclosure may also have other overall shapes such as rectangular, again depending, in part, on the size of parts intended to be fabricated. For example, in certain embodiments, an enclosure may have a characteristic length from about 10 inches to about 13 inches, or any other suitable dimension.

In certain embodiments, an electronics box is mounted within the enclosure. An electronics box houses the electronics for running the apparatus and for interfacing with an external power source. The electronics box may include a fan for reducing and/or controlling the internal temperature of the electronics box. The electronics box may or may not be thermally insulated from the rest of the internal volume of the enclosure.

In certain embodiments, the molding or build material is provided as a filament. In certain embodiments, the molding material comprises a thermoplastic. Molding materials for 3D printing systems are known in the art. The molding material can be retained as a filament on a spool that is fed into the extruder.

In certain embodiments, a filament spool can be mounted on a spool mounted external or on the side of the 3D printer. A filament spool can be mounted to a back panel of a 3D printer using brackets attached to the back panel of the enclosure by a snap-fit connection. Each bracket can extend from the back panel and includes a snap-fit recession. Ends of a filament spool can be configured to be snap-fit into recessions. The snap fit attachment of the spool retention brackets can facilitate ease of assembly and disassembly and thereby facilitate ease of use with other filament spool designs and/or sizes. In other embodiments, for example as shown in FIG. 1, a filament coil can be held in a cavity within a top cover insert.

A platform on which a 3D object is fabricated is housed within the enclosure. A build platform can be planar and in certain embodiments may include a surface configured to retain a 3D object during fabrication and facilitate release after the part is fabricated. For example, the platform may contain a polymeric film and/or be treated with an adhesive.

The horizontal orientation of a build platform may be adjustable to facilitate orienting the platform such that it is parallel to the travel of the X-carriage and the Y-carriage or more specifically the in-plane motion of the extruder nozzle. Leveling of the build platform with respect to the X-carriage and the Y-carriage can be effected, for example, by spring-loaded screws or other suitable device. The adjustment can be made using a slot, nut, or using wing-nut or thumbscrew.

In certain embodiments, a build platform is retained by a platform mounting bracket. A platform mounting bracket can includes grommeted-guides and threaded inserts. Threaded inserts can be configured to retain a vertical screw drive rod and grommeted guides can be configured to retain vertical guide rods. These elements are used to control the vertical position of build platform.

In certain embodiments, the vertical position of the build platform can be adjusted manually, for example, using a thumbscrew. Thumbscrews can be used, for example, to lower the platform away from the extrusion head after a part has been fabricated. Thumbscrews may be configured such that a portion of the thumbscrew extends outside of the enclosure for ease of access and use.

The position of the extruder in the horizontal plane is controlled by the X-carriage and the Y-carriage. The X-carriage is configured to adjust the left-right position of the extruder when viewing the enclosure from the front, where the front refers to the panel with the viewing window. The Y-carriage is configured to adjust the front-back position of the extruder. The X-carriage and the Y-carriage are mounted to a gantry.

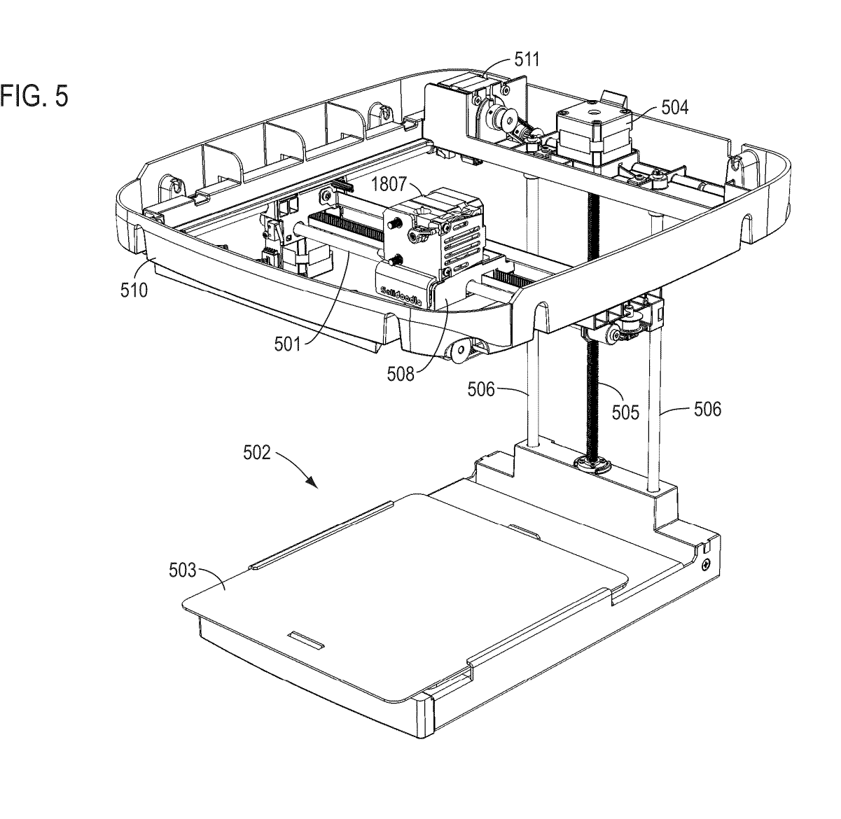

In FIG. 5, the X-carriage assembly 501 is shown positioned within a three-dimensional printing system. X-carriage assembly 501 includes extruder 507 mounted on extruder mount 508. FIG. 5 also shows build platform 502 including a slidable build plate 503. The vertical height or position of gantry 510 with respect to build plate 503 can be controlled by vertical control motor 504 and is operably coupled to drive screw 505. Gantry 510 is configured to move along vertical guide rods 506. FIG. 5 also shows Y-carriage drive motor 511.

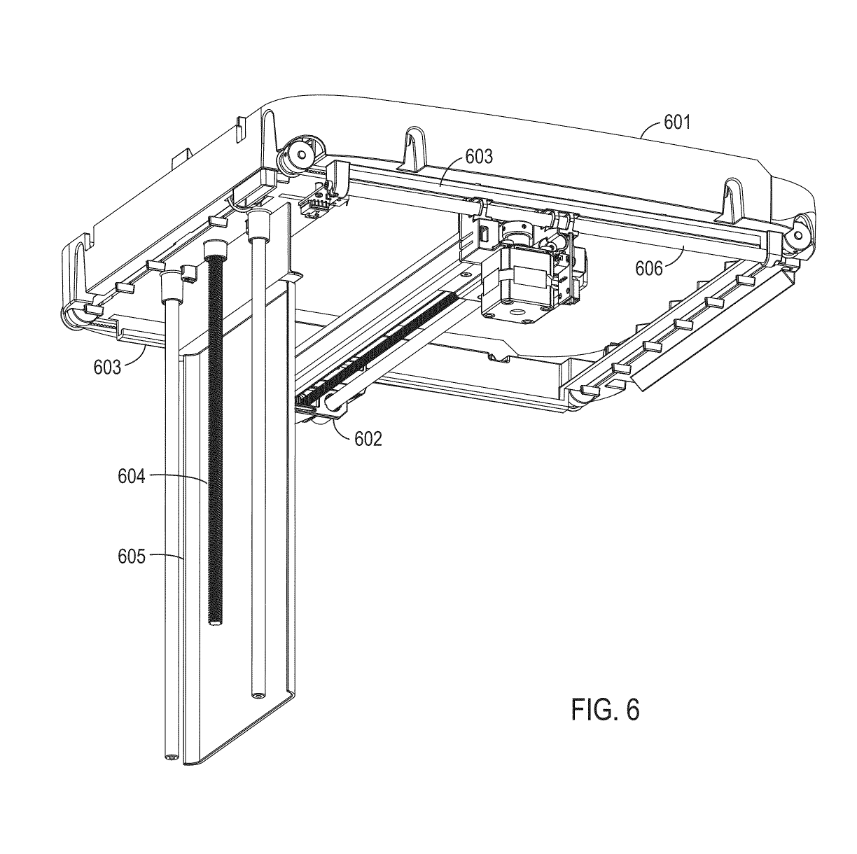

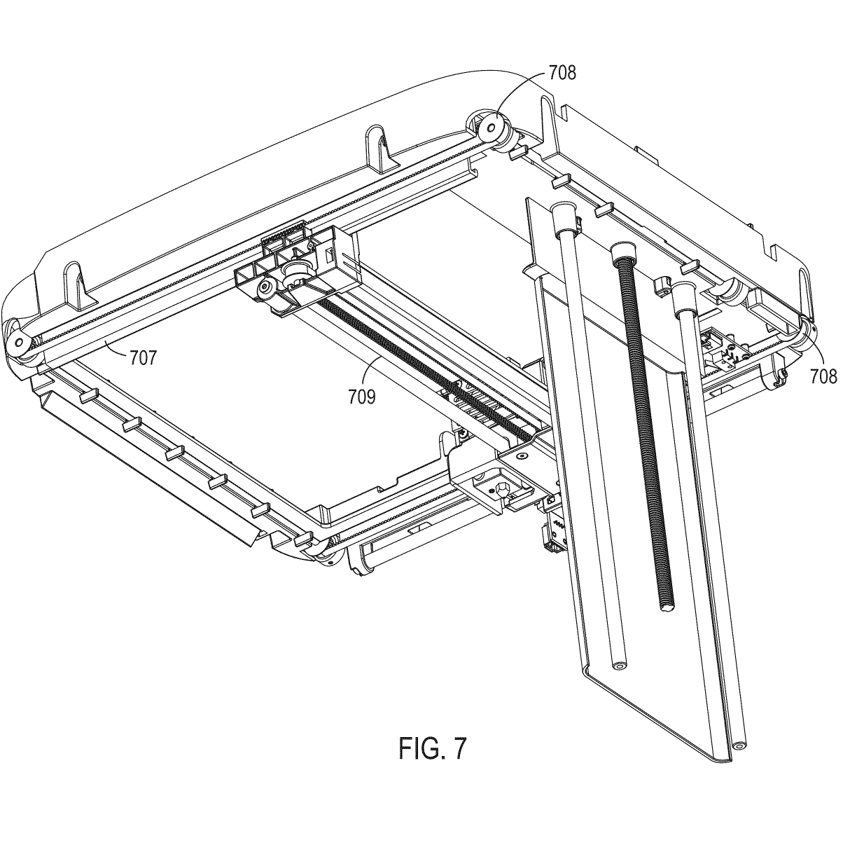

Perspective views of the gantry with the X-carriage and the Y-carriage are shown in FIGS. 6 and 7. FIGS. 6 and 7 show gantry 601, X-carriage 602, Y-carriage 603, and vertical drive screw 604 and vertical guide rods 605. Also, as shown in these figures, on one end, X-carriage 602 is slidably mounted to the Y-carriage by rod 606, and as shown in FIG. 7, on the other end is slidably mounted to a bracket 707. Both sides of the Y-carriage include drive belts 708 operably coupled to the X-carriage 709.

The X-carriage is mounted to the Y-carriage. In certain embodiments, the X-carriage includes two parallel rods with the ends of each rod mounted on respective Y-carriage rods.

One end of each of the two X-carriage rods is mounted to one of the Y-carriage rods with a mounting having a spherical linear bearing attached to the Y-carriage rod. The other end of each of the X-carriage rods is attached to the other Y-carriage rod with a mounting fixture having a slider joint. The slider joint mount can be made of low friction material such as Derlin®, nylon, or other suitable material. This configuration in which one end of the X-carriage is attached to a Y-carriage drive using a spherical linear bearing and the other end is attached to a Y-carriage rod using a slider joint minimizes binding despite slight misalignment between the two Y-carriage rods.

Each of the X-carriage mounting fixtures are operably connected to a common Y-carriage drive rod with drive belts. Y-carriage drive rods in turn operably connected to a Y-drive motor by a drive belt.

X-drive motor is mounted on slider bearing mount and an extrusion head is mounted on the two X-carriage rods in a manner similar to that in which the X-carriage is mounted to the Y-carriage. That is, the extrusion head is mounted to one of the X-carriage rods with a spherical linear bearing and to the other X-carriage rod with a slider joint. The X-position of extruder can be controlled by a drive belt operably connected to the X-drive motor and to the extruder.

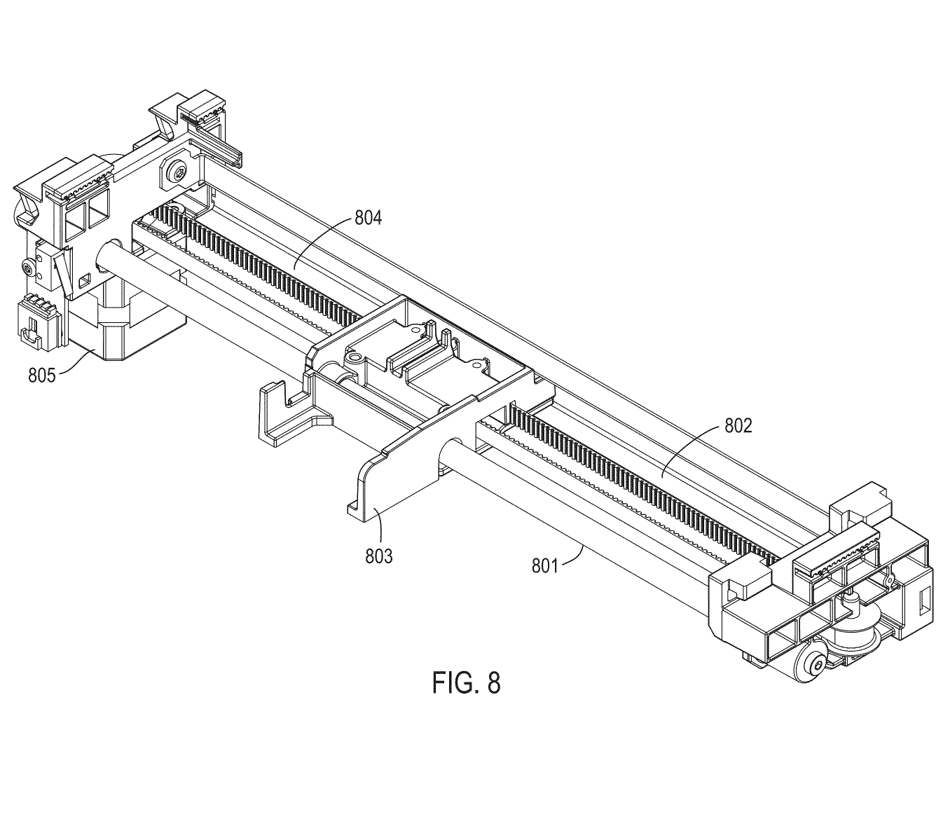

FIG. 8 shows a perspective view of an X-carriage. The left side of the X-carriage is configured to slidably mount to a Y-carriage rod and the right side of the X-carriage is configured to slidably mount to a planar surface or bracket. The X-carriage includes an X-carriage rod 801 a plate or bracket 802. Extruder mount 803 is slidably mounted to X-carriage rod 801 and is slidably mounted to plate 802. Positioning of extruder mount 803 can be controlled by drive belt 804, which is operably coupled to X-carriage motor 805. Drive belt 804 is operably coupled to extruder mount 803.

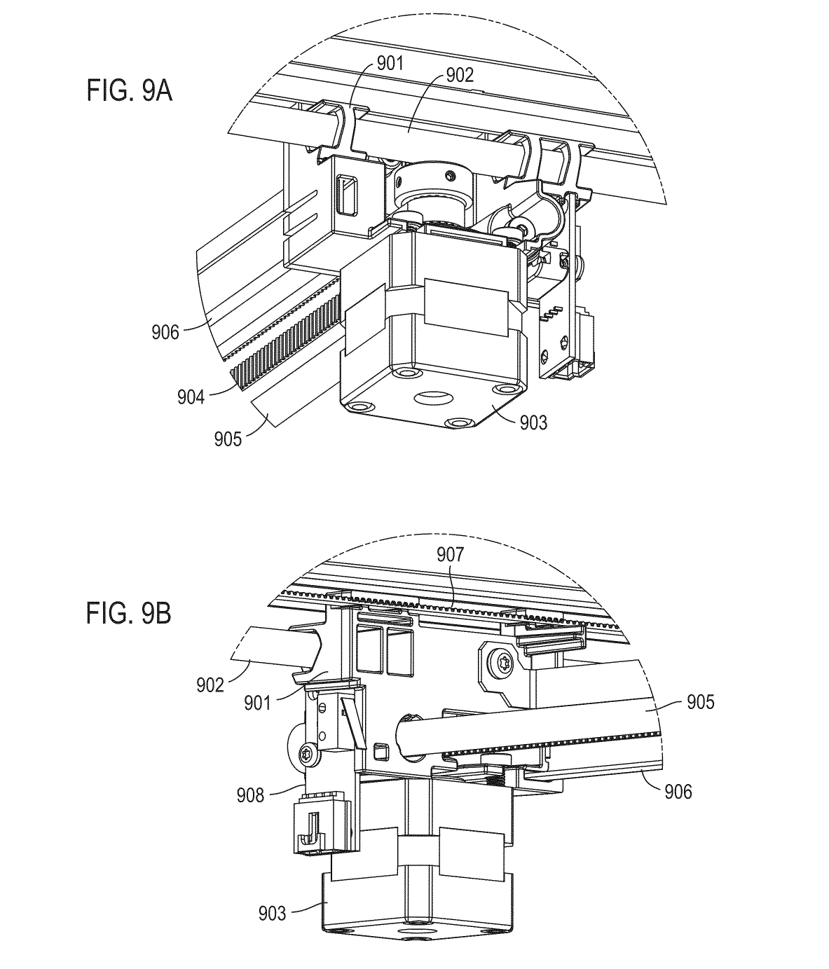

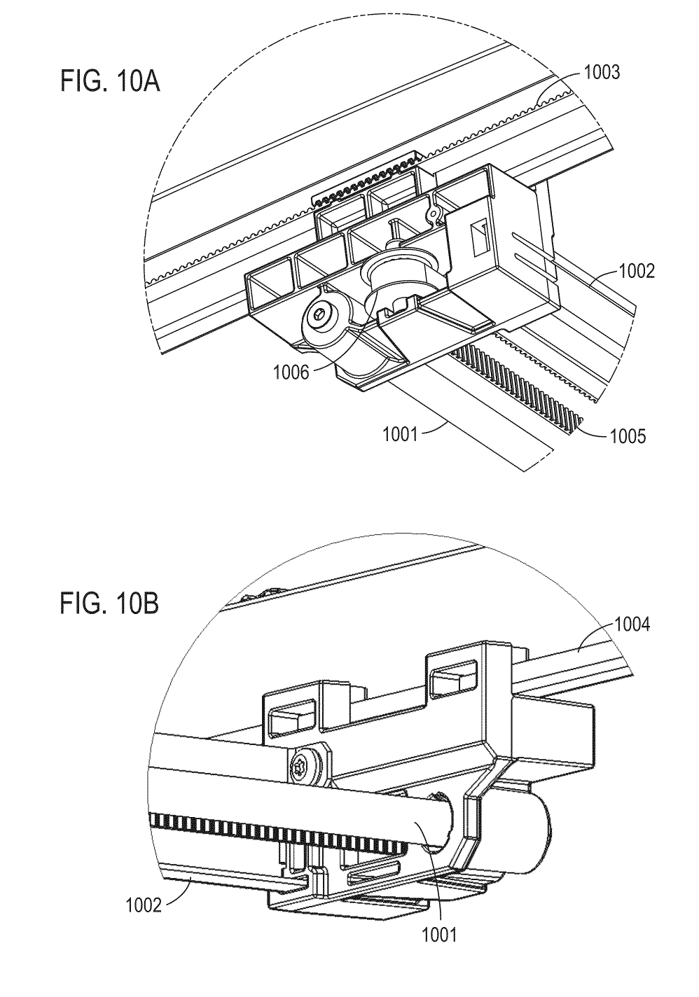

FIGS. 9A-10B show detailed views of assemblies for mounting the X-carriage to the Y-carriage. FIGS. 9A and 9B show two views of the left side of the X-carriage assembly coupled to a Y-carriage rod. FIGS. 10A and 10B show views of the right side of the X-carriage assembly where it is mechanically coupled to the Y-carriage assembly. As shown in FIGS. 10A and 10B, the left side of the X-carriage assembly rides along a plate or bracket.

FIGS. 9A and 9B show left X-carriage mounting assembly or bracket including slidable coupling 901 mounted to Y-carriage rod 902, X-carriage drive motor 903, X-carriage drive belt 904, X-carriage rod 905, and X-carriage plate or bracket 906. The X-carriage mounting bracket is also operably coupled to Y-carriage drive belt 907. A limit switch 908 is also shown mounted to the X-carriage mounting bracket.

FIGS. 10A and 10B show the right X-carriage mounting assembly or bracket. X-carriage rod 1001 and X-carriage bracket 1002 are mounted to the right X-carriage mounting assembly. The X-carriage mounting assembly is operably coupled to Y-carriage drive belt 1003. The X-carriage mounting assembly is also configured to slidably mount to Y-carriage bracket 1004. The X-carriage mounting assembly also includes a capstan 1006 for retaining X-carriage drive belt 1005.

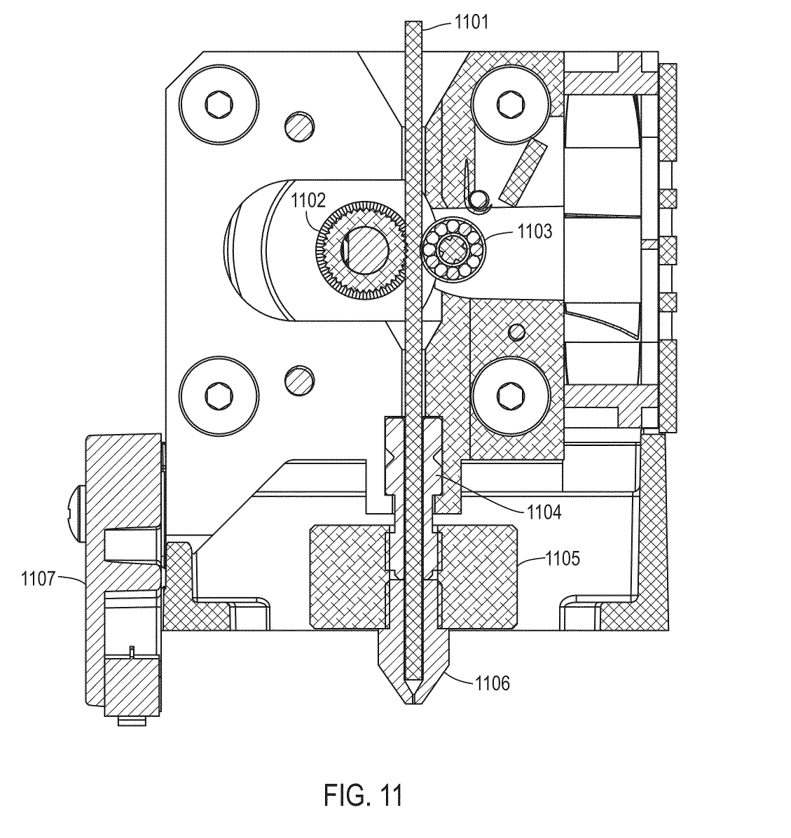

FIGS. 11-16 show various aspects of an extruder.

FIG. 11 shows a cross-sectional view of an extruder showing filament 1101, filament drive gear 1102, pressure bearing, 1103, barrel 1104, heating block 1105, and extrusion nozzle 1106. A vertical measurement device 1107 is mounted to the side of the extruder. As shown, heating block 1105 is thermally isolated from other parts of the extruder except barrel 1104.

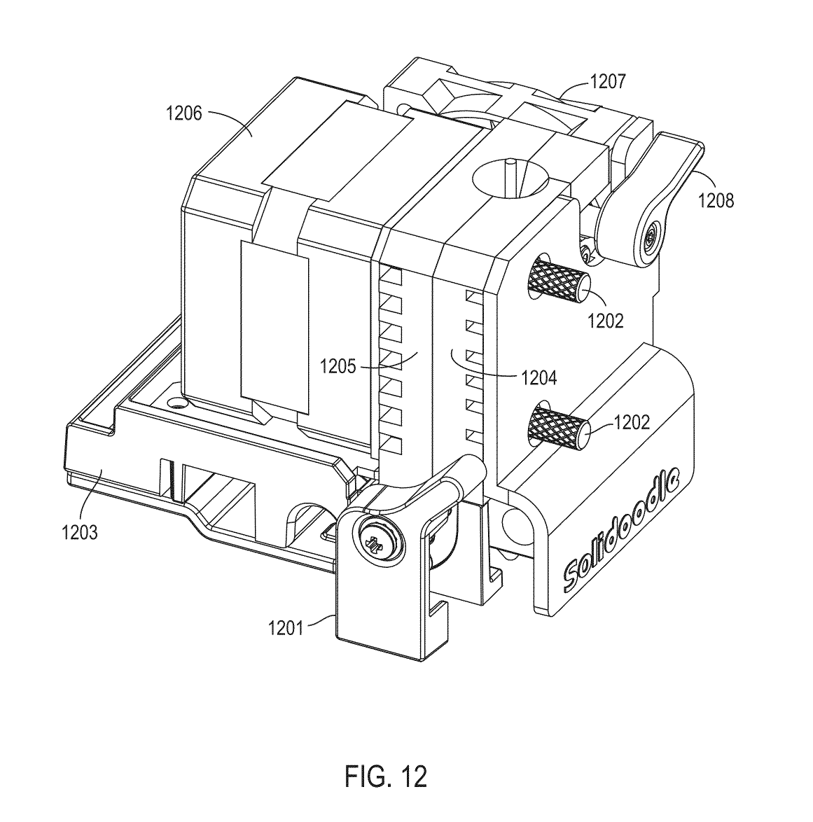

An assembly view of an extruder is shown in FIG. 12. Latch 1201 is configured to securely mechanically couple the extruder to extruder mount 1203. Thumb screws 1202 mount the front cooling plate 1204 to back cooling plate 1205 to facilitate easy access to the entire filament guide path to also enable removal of the hot end of the filament. FIG. 12 also shows extruder feed motor 1206 and fan 1207 and extruder bearing pivot handle 1208.

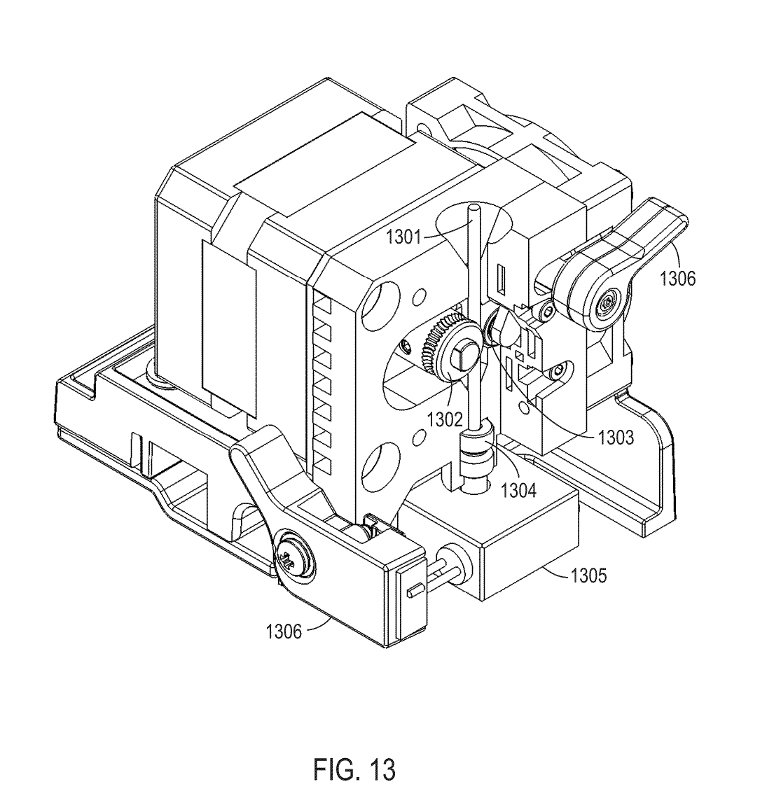

FIG. 13 shows a cut-away view of an extruder with the front removed by the thumb screws. FIG. 13 shows filament 1301, filament drive gear 1302, pressure bearing 1303, barrel 1304, heating block 1305, and latches 1306.

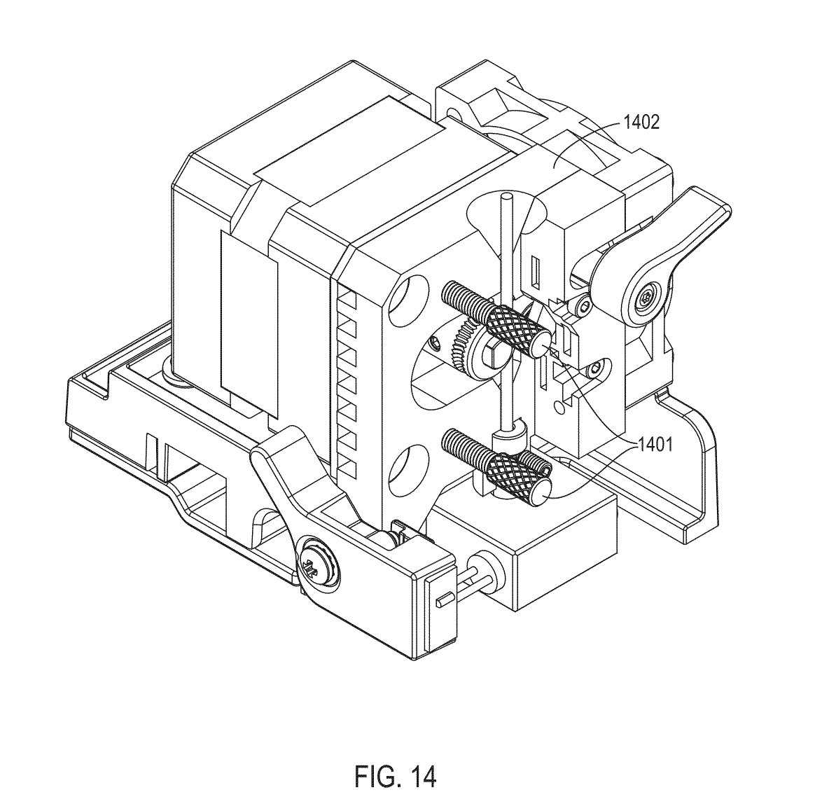

FIG. 14 is similar to FIG. 13 with the addition of thumbscrews 1401 coupled to back cooling plate or heat sink 1402.

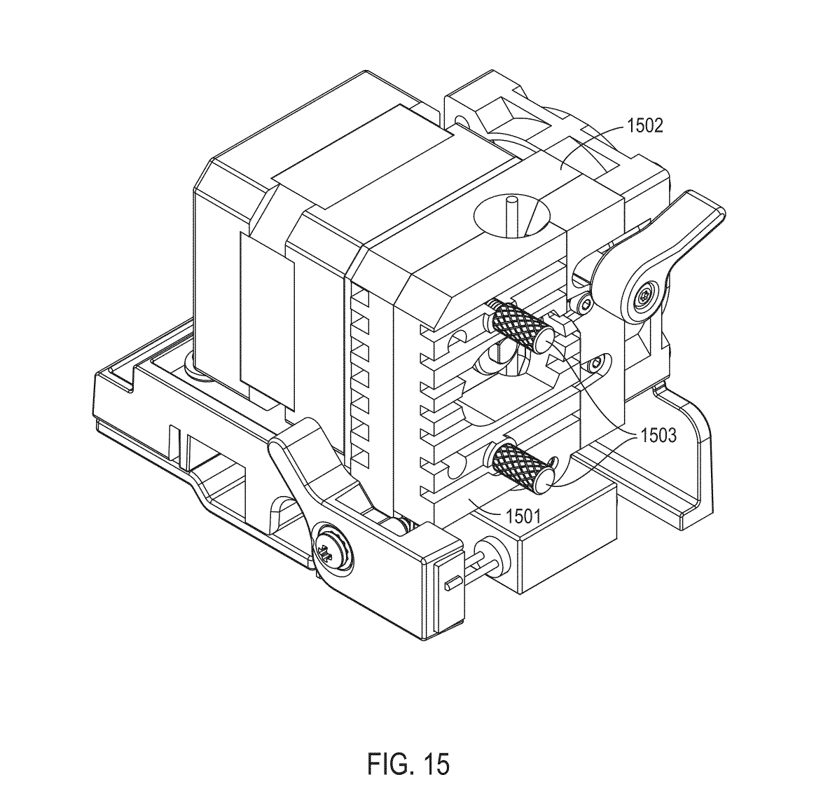

FIG. 15 shows front heatsink 1501 mounted onto the back heatsink 1502 with thumbscrews 1503.

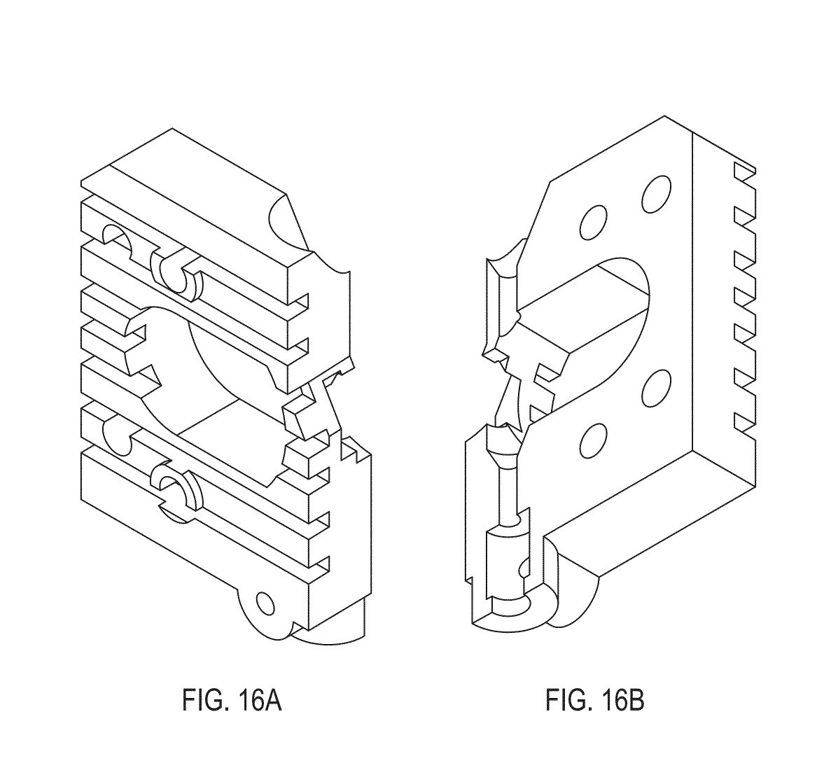

A detailed view of the heatsink is shown in FIGS. 16A and 16B show cavities for retaining a melt tube or barrel and for feeding a filament.

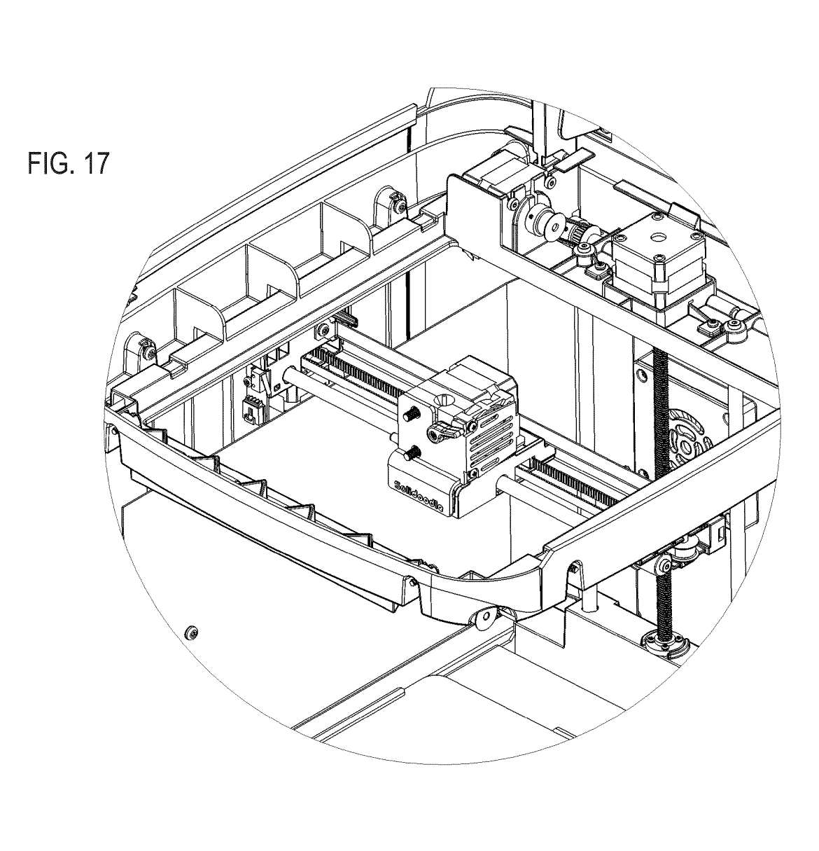

FIG. 17 shows an assembled extruder mounted to an X-carriage.

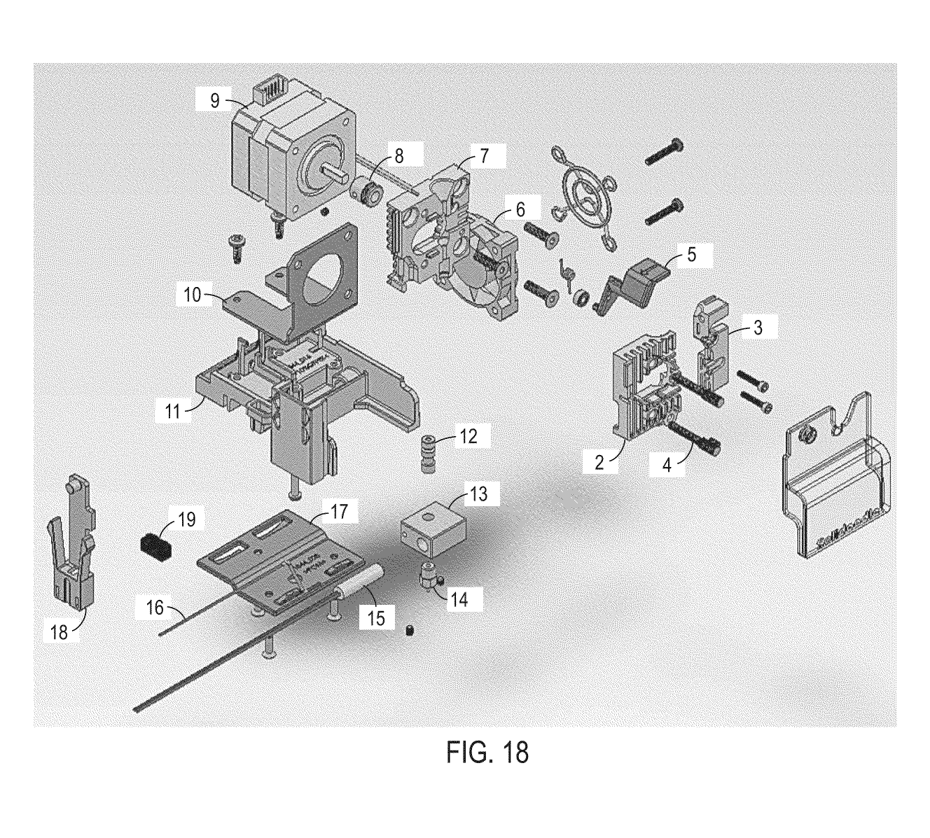

FIG. 18 shows an exploded view of the extruder and the extruder mount. FIG. 18 includes filament window 1801, left front heat sink 1802, right front heat sink 1803, knurled thumbscrews 1804, extruder bearing pivot handle 1805, fan 1806, back heat sink 1807, print head filament gear 1808, extruder motor 1809, extruder motor bracket 1810, print carriage 1811, melt tube 1812, melt chamber or heater block 1813, extruder tip 1814, cartridge heater 1815, thermistor 1816, extruder bottom plate 1817, extruder leveler 1818, and limit switch 1819.

Using the disclosed systems objects having a build volume up to about 8×8×8 in³ can be fabricated. In certain embodiments, the systems are characterized by a print head translation speed of 50 mm/sec to 100 mm/sec. In certain embodiments, the print resolution is about 1 mm layer height.

In certain embodiments, a 3D printing system includes a sub-system for leveling the build platform with the extruder head. A leveling sub-system can include a mechanism for determining a distance between the build platform and the extruder head and a software algorithm for adjusting the height of the extruder head with respect to the build platform depending on the location or X-Y position of the extruder head with respect to the build platform. In other embodiments, the build platform can be leveled with respect to the X-Y motion of the extruder head by mechanically adjusting the height or tilt of the build platform with respect to the extruder head based on the mechanism for determining the distance between the build platform and the extruder head. In certain embodiments, leveling the build platform with respect to the extruder head can be done manually and in certain embodiments can be accomplished using drive motors. In certain embodiments, the leveling sub-system can maintain the planarity of the build platform and the X-Y motion of the extruder head to less than 0.5 mm, to less than 0.3 mm, and in certain embodiments, to less than 0.1 mm.

In certain embodiments, it is desirable to level the build platform with respect to the extruder head before an object or model is built and the level adjustment remains fixed during building a model.

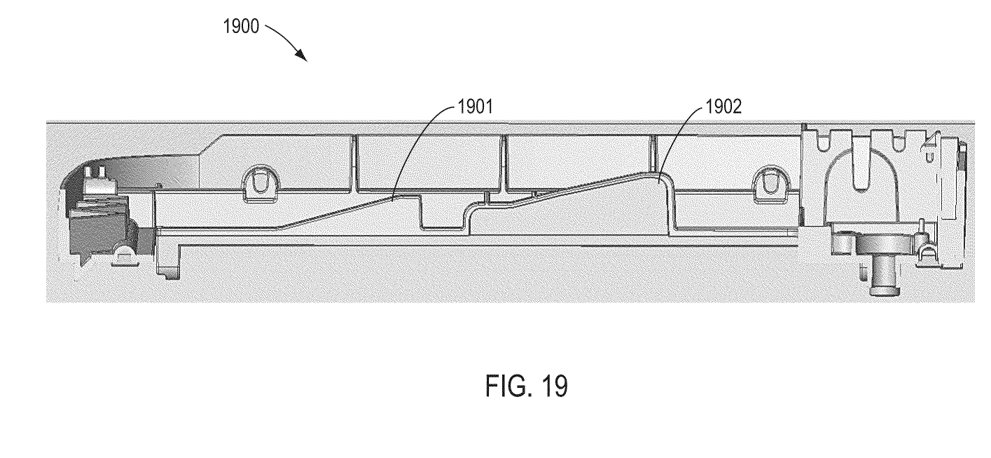

Certain aspects of a leveler probe and apparatus and methods associated with the leveler probe are illustrated in FIGS. 19-30.

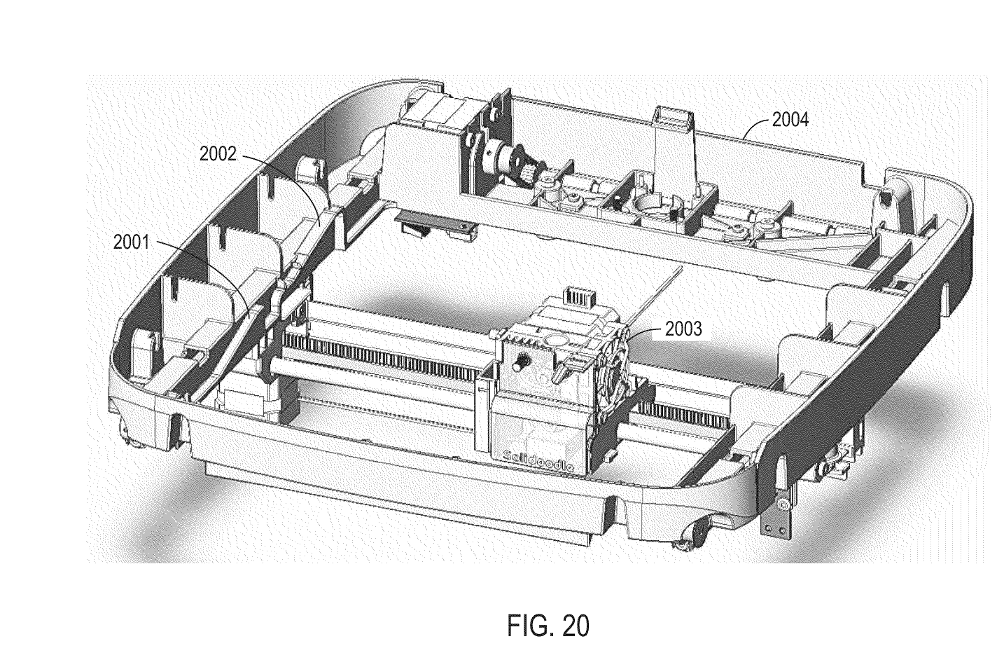

FIGS. 19 and 20 show side views of a leveler ramp and a perspective view of a gantry assembly with an extruder heat mounted on the X-carriage, respectively. The leveler ramp shown in FIG. 19 is located on the left side of the gantry in FIG. 20. The leveler ramp is used to adjust the height of the leveler probe with respect to the build platform. In the down position, a leveler probe can make measurements used to level the build apparatus. In the retracted or up position, the leveler probe is moved above the surface of the build platform and above the extruder nozzle to enable printing.

FIG. 19 shows a side-on view of a leveler ramp 1900 including a raising ramp 1901 and a lowering ramp 1902. FIG. 20 shows a perspective view of the leveler ramp including lowering ramp 2001 and raising ramp 2002 and the relationship of the leveler ramp with the extrusion head 2003 and other assemblies mounted on the gantry 2004.

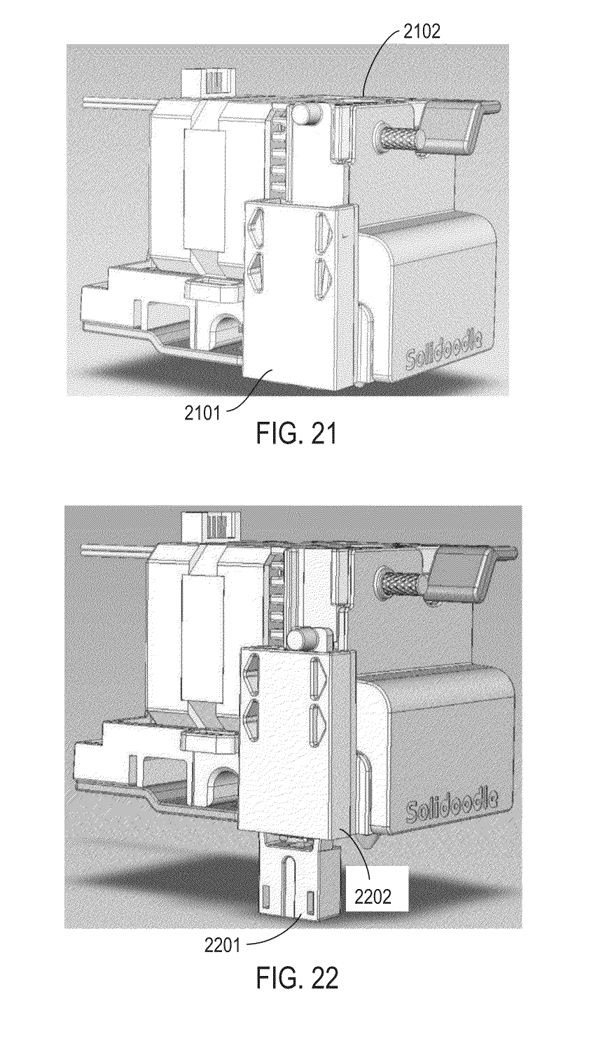

FIG. 21 shows view of the leveler probe in the up position. The leveler probe housing 2101 is mechanically coupled to the extruder head 2102. The leveler probe is contained within leveler housing 2101. In the view shown in FIG. 21, the leveler housing is mounted on the right side of the extruder head and includes four snap-fit retention slots arranged to provide two vertical retention positions. The bottom of the leveler probe is shown to be fully retracted into the leveler housing, and the extruder nozzle (not shown) extends below the bottom of the leveler housing and the leveler probe such that the leveler assembly does not encumber building a model.

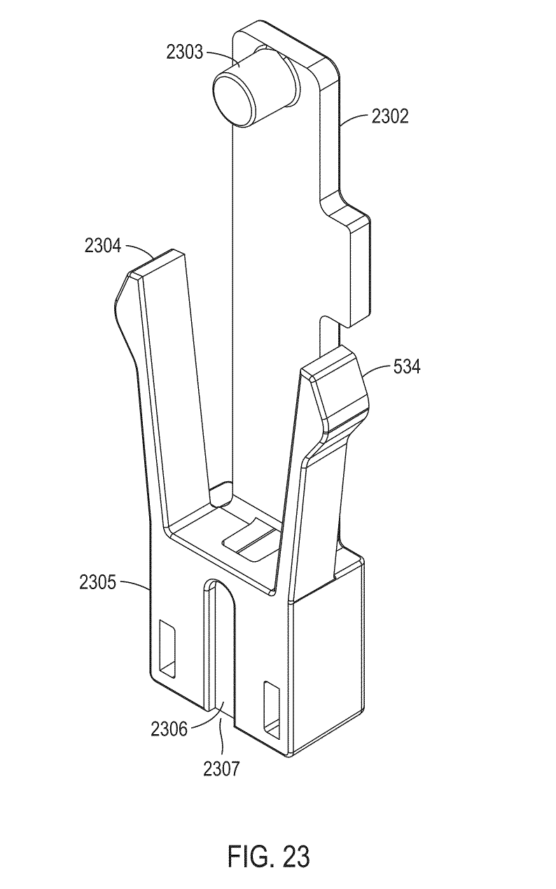

FIG. 22 shows a view of the extruder similar to that of FIG. 21 but with the leveler probe in the activated or down position. As shown in FIG. 22, in the down position, the leveler probe 2201 extends beyond the base of the leveler housing 2202 and beyond the extension of the extruder nozzle (not shown) to engage the build platform.

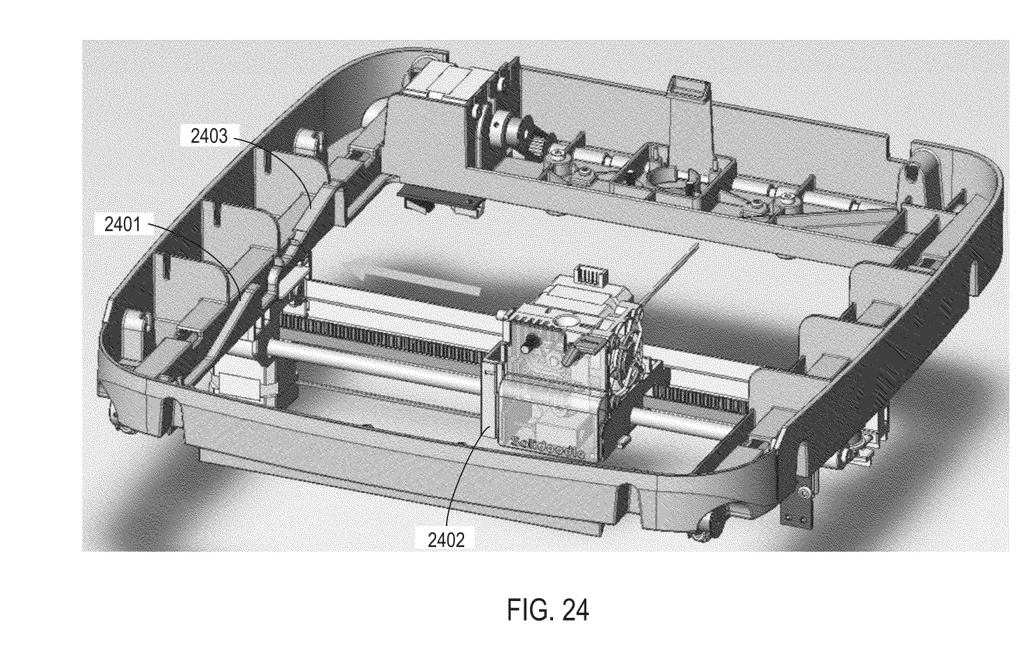

An embodiment of a leveler probe housing is shown in FIG. 23, Leveler probe housing includes guide 2302, détente 52303, snap-fit retainers 52304, and housing 2305 defining cavity 2306, configured or dimensioned to retain a measurement device 2307. Measurement device 2307 can be retained within cavity 2306 using snap-fit features. Although snap-fit retention mechanisms are useful for ease of assembly and disassembly of the measurement device, other mechanisms can be used to couple a measurement device to the leveler housing.

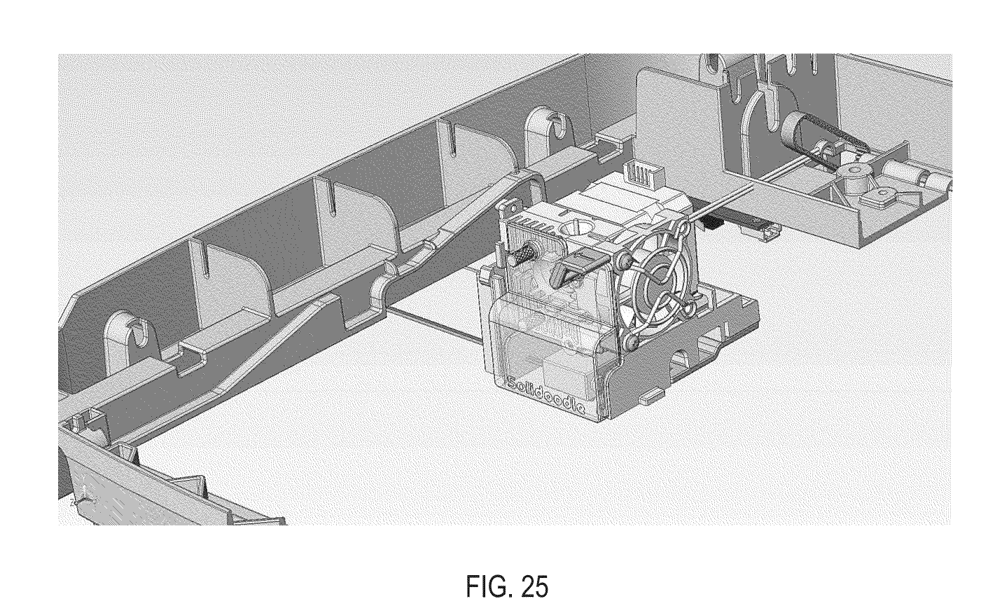

As shown in FIG. 24, the leveler ramp includes a first raising ramp 2401 configured to raise the leveler probe 2402 up and a second lowering ramp 2403 configured to lower the leveler probe. In certain embodiments, the raising ramp 2401 includes a flat sidewall and is configured such the détente sits on top of the ramp. In certain embodiments, the lowering ramp includes a lip on the upper surface that faces toward the center of the printing apparatus. The lip and ramp are configured such that the détente engages the second ramp under the lip.

A method for changing the position of the leveler probe between the up and down positions is illustrated in FIGS. 24-30.

Beginning with FIG. 24, which shows a perspective view of the gantry with the extruder head mounted on the X-carriage (not shown) and a leveler ramp on the left side of the gantry. From a first position, with the leveler probe in the up position, the extruder head can be moved toward the left side of the gantry such that the leveler probe housing makes contact with or is situated near top of the lowering ramp 2403. In this position, when the extruder head and the leveler probe housing are moved toward the front of the printer, the leveler probe détente engages the lowering ramp.

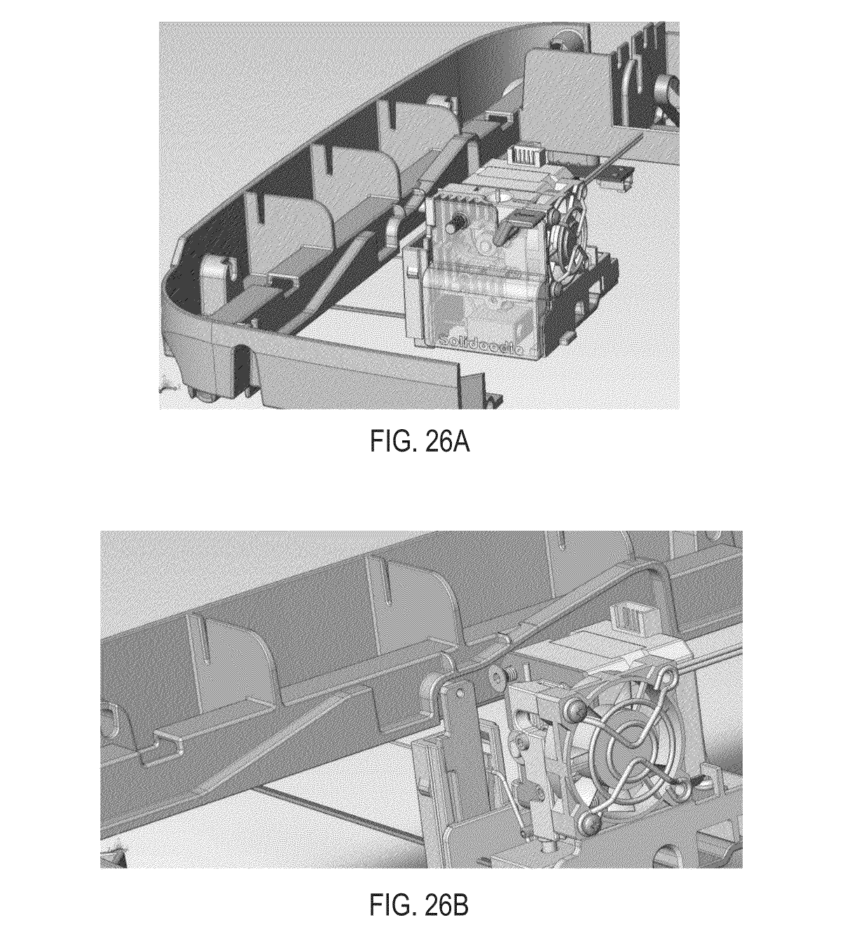

As shown in FIG. 25, the détente 2501 of the leveler probe engages the lowering ramp 2502 toward the right end and below the lip 2503. As the extruder head 2504 moves forward, the lip engages the détente and forces the détente and consequently the leveler probe downward causing the snap-fit features to engage into the lower position of the leveler probe housing. In FIG. 25 the détente 2501 is shown beneath the lip 2503 toward the upper end of the rear or lowering ramp 2502 just before the extruder head is moved forward to lower the leveler probe.

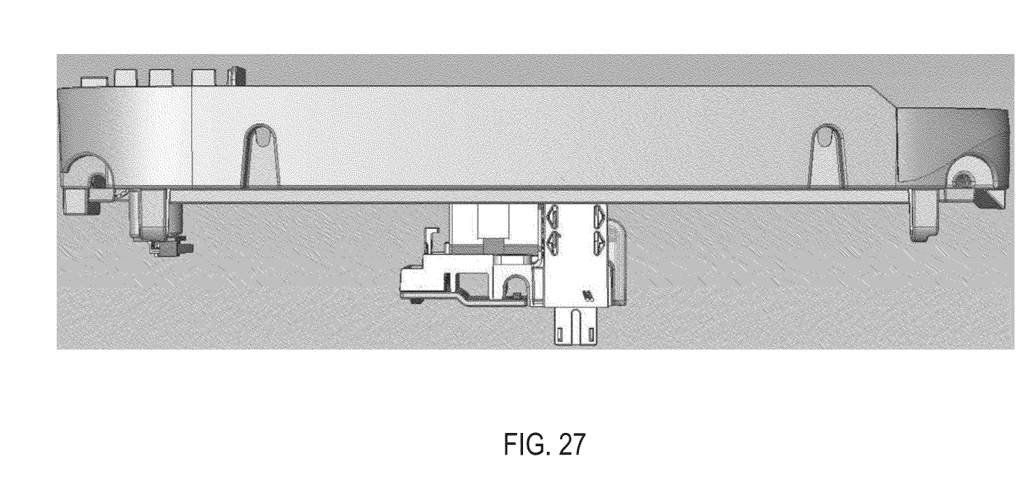

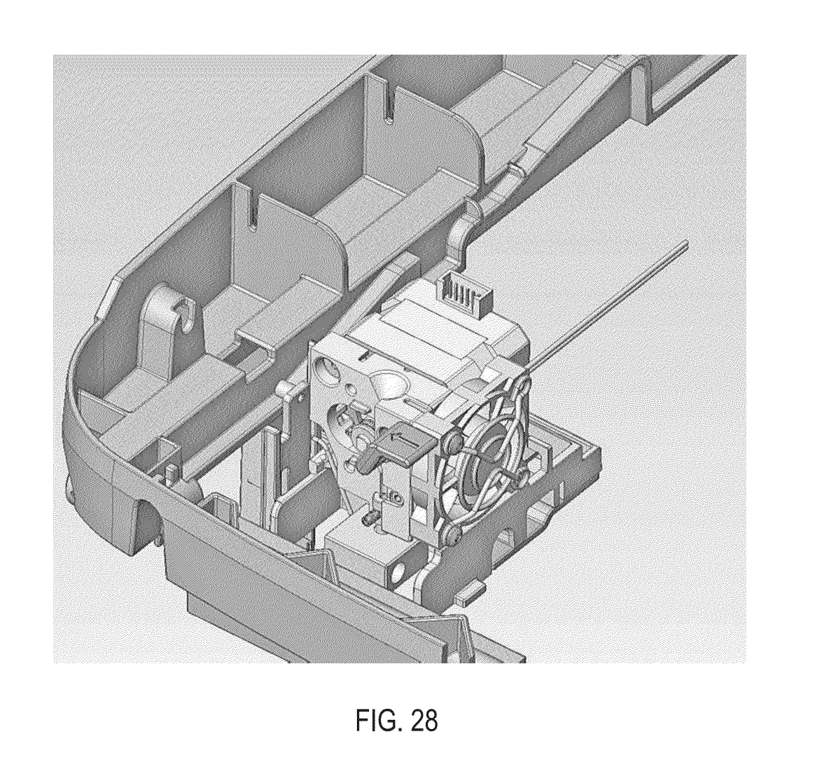

FIG. 26A shows the relationship of the détente and lowering ramp during the lowering process and FIG. 26B shows the relationship of the lip, rear ramp, détente, leveler probe and leveler housing at the completion of the probe lowering process. A side view of the leveler probe in the lowered or measurement position is shown in FIG. 27. With the leveler probe in the lowered position, the probe and extruder head can be moved to various positions on the build platform and the distance between the probe and the build platform determined. The measurements and X-Y position on the build platform can be stored in memory and used to provide a level build surface.

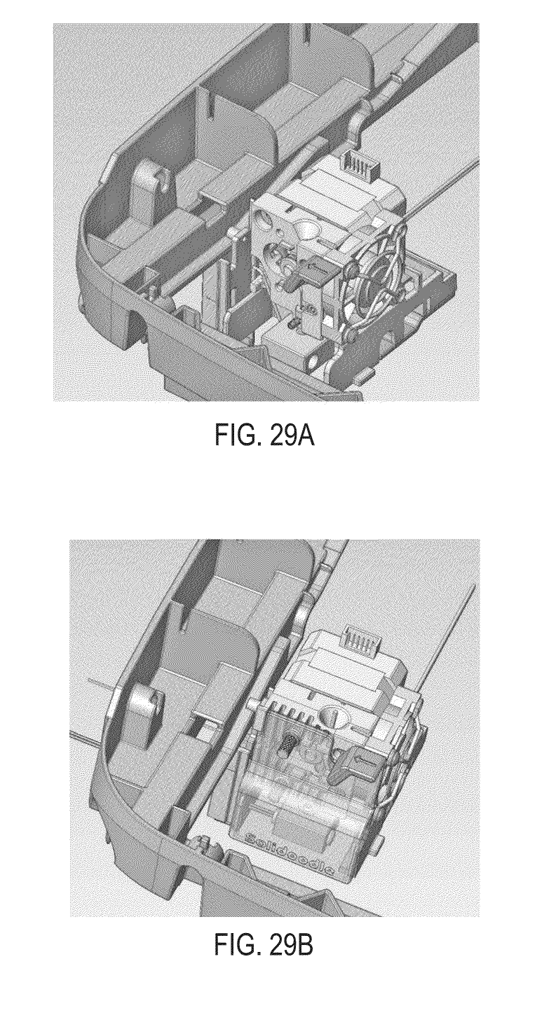

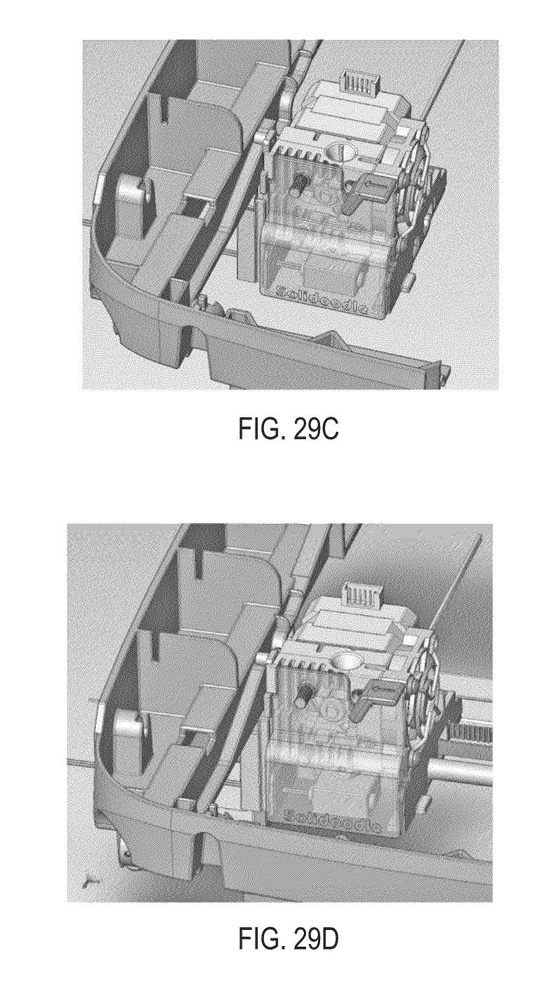

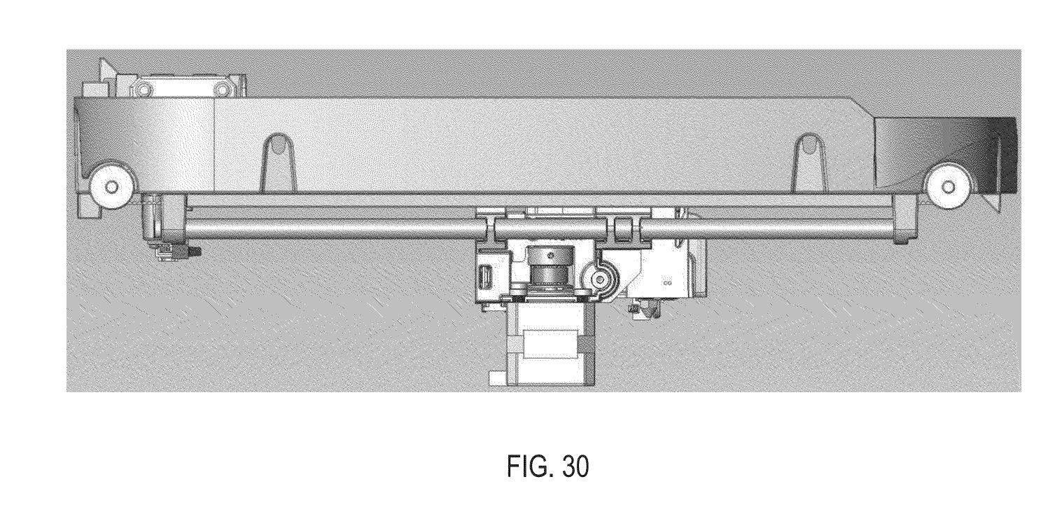

After all measurements used to calculate a leveling algorithm have been accumulated and stored, the leveler probe can be raised to a build position. Raising the leveler probe is accomplished using the raising ramp. As shown in FIG. 28, the extruder head 2801 and leveler probe 2802 are positioned such that the détente 2803 engages the front or left portion of the raising ramp 2804. In this configuration, the détente rests on is near the raising ramp. As the extrusion head and détente move toward the back of the printer the leveler probe is raised to cause the snap-fit features to engage in the up or build position. In the up position the leveler probe is locked into a position so as not to interfering with model building. The relative motion of the extrusion head and the détente with respect to the front ramp during the raising process are shown in FIGS. 29A-29D. Initially, the détente is positioned above the front portion of the ramp (FIG. 29A) and as the extruder moves toward the rear of the apparatus, the détente rides along the ramp causing the leveler probe to lift (FIG. 29B). At the end of the ramp the leveler probe will be raised and locked into the up position (FIG. 29C and FIG. 29D). A side view showing the relationship of the extruder head, extrusion nozzle and leveler housing when the leveler probe is in the fully retracted or up position is shown in FIG. 30.

The leveler measurement device can be a limit switch used in conjunction with the Z-axis controller. The orientation of the build platform with respect to the limit switch attached to the leveler probe can be measured at various X-Y positions including, for example, toward the four corners of the build platform. A non-planarity of the build platform and the motion of the extrusion head in the X-Y plane can be determined. The measured non-planarity can then be compensated for by controlling the Z position of the X-Y gantry during X and Y motion of the extrusion head.

3D printing systems provided by the present disclosure may be used to fabricate objects. The platform is leveled with respect to the translation of the X-carriage and Y-carriage by adjusting the platform leveling features. A filament of heat sensitive material such as a thermoplastic material is manually fed into the extruder to cause the filament to engage with the filament drive screw. Power is applied to the heater block attached to the extruder heat to an appropriate temperature to melt the heat sensitive material to a suitable viscosity. The position of the extruder nozzle with respect to the platform is controlled by the X-carriage, Y-carriage, and platform Z-drive, which are in turn controlled by an output from a computer aided design system adapted for 3D printing.

Finally, it should be noted that there are alternative ways of implementing the embodiments disclosed herein. Accordingly, the present embodiments are to be considered as illustrative and not restrictive. Furthermore, the claims are not to be limited to the details given herein, and are entitled their full scope and equivalents thereof.

What is claimed is:

1. A leveling sub-system for leveling a three-dimensional printing system, comprising:
a vertically adjustable leveler probe mounted to an extrusion head; and
a leveler ramp mounted to a gantry assembly, wherein the leveler ramp comprises a lowering ramp and a raising ramp.

2. The leveling sub-system of claim 1, wherein the lowering ramp and the raising ramp are configured to vertically adjust a position of the leveler probe when the leveler probe is moved along the lowering ramp or the raising ramp.

3. The leveling sub-system of claim 1, wherein the leveler probe comprises a détente configured to engage the lowering ramp and the raising ramp.

4. The leveling sub-system of claim 1, wherein the leveler probe comprises a distance measurement device.

5. The leveling sub-system of claim 4, wherein the distance measurement device comprises a limit switch.

6. A method of leveling a three-dimensional printing system comprising using the leveling subsystem of claim 1.

7. A method of leveling a three-dimensional printing system comprising:
providing a build platform; an X-Y translation gantry disposed over the build platform; a leveler ramp mounted to the X-Y translation gantry; an extrusion head mounted to the X-Y translation gantry;
and a leveler probe mounted to the extrusion head, wherein the leveler ramp comprises a lowering ramp and a raising ramp;
from a starting position, moving the extrusion head toward the leveler ramp to cause the leveler probe to engage the lowering ramp;
moving the extrusion head and the leveler probe along the lowering ramp to lower the leveler probe toward the build platform to a measurement position;
moving the lowered leveler probe with respect to the build platform to determine the distance between the leveler probe and the build platform at various locations across the build platform;
from an ending position, moving the extrusion head toward the leveler ramp to cause the leveler probe to engage the raising ramp; and
moving the extrusion head and the leveler probe along the raising ramp to raise the leveler probe away from the build platform to a build position.

8. The method of claim 7, comprising:
using the determined distance at various locations across the build platform to calculate a leveling algorithm; and
using the leveling algorithm to adjust the position of the extrusion head with respect to the build platform during building of a three-dimensional object.

9. A translation carriage for a three-dimensional printing system, wherein the translation carriage comprises an X-carriage comprising:
an X-carriage rod;
a guide rail mounted parallel to the X-carriage rod;
an extruder mount slidably coupled to the X-carriage rod and slidably coupled to the guide rail; and
an X-carriage drive belt operatively coupled to the extruder mount, wherein the X-carriage drive belt is configured to move the extruder mount along the X-carriage rod and along the guide rail.

10. The translation carriage of claim 9, comprising a first Y-carriage mount and a second Y-carriage mount, wherein,
a first end of the X-carriage rod and a first end of the guide rail is mounted on the first Y-carriage mount; and
a second end of the X-carriage rod and a second end of the guide rail is mounted on the second Y-carriage mount.

11. The translation carriage of claim 10, comprising an X-carriage drive mounted to the first Y-carriage mount and coupled to the X-carriage drive belt.

12. The translation carriage of claim 10, wherein,
the first Y-carriage mount is slidably coupled to a first Y-carriage rod; and
the second Y-carriage mount is slidably coupled to the second Y-carriage rod.

13. The translation carriage of claim 10, wherein one of the first Y-carriage mount and the second Y-carriage mount is operatively coupled to a Y-carriage drive belt.

14. An extrusion head for a three-dimensional printing system, wherein the extrusion head comprises:
a front plate;
a front heat sink; and
a back heat sink, wherein,
each of the front heat sink and the back heat sink comprise a channel configured to pass a printing filament and configured to retain at least a portion of an extruder barrel; and
the front plate and the front heat sink are mounted to the back heat sink with at least two thumbscrews.

15. The extrusion head of claim 14, wherein the channel is further configured to retain an extruder barrel.

16. The extrusion head of claim 15, comprising an extruder barrel retained by the front heat sink and the back heat sink, wherein,
the extruder barrel comprises an upper portion and a lower portion;
the upper portion fits within the channel and is thermally and mechanically coupled to the front plate and to the back plate; and
the lower portion is thermally coupled to a nozzle heating block.

17. An enclosure for a three-dimensional printing system, wherein the enclosure comprises:
four substantially vertical side walls;
a hinged insert configured to mate with each of the four vertical side walls, wherein the hinged insert comprises a recess for mounting a filament spool and a hole for feeding filament to an extruder head; and
a hinged top cover configured to mate with and to cover the hinged insert.
